(19) United States
(12) Patent Application Publication
(10) Pub. No.: US 2002/0055844 A1
(43) Pub. Date: May 9, 2002

(54) Speech user interface for portable personal devices

(76) Inventors: Lauren L'Esperance, Arlington, MA (US); Alan Schell, Hopkinton, MA (US); Johan Smolders, Brugge (BE); Erin Hemenway, Somerville, MA (US); Piet Verhoeve, Menen (BE); Eric Niblack, Norwood, MA (US); Mark Goslin, Chelmsford, MA (US)

Correspondence Address: BROMBERG & SUNSTEIN LLP, 125 SUMMER STREET, BOSTON, MA, 02110-1618, US

(21) Appl. No.: 09/793,377

(22) Filed: Feb. 26, 2001

Related U.S. Application Data
(60) Provisional application No. 60/185,143, filed on Feb. 25, 2000.

(51) Int. Cl. G10L 13/08

(52) U.S. Cl. 704/260

(57) ABSTRACT

A handheld electronic device such as a personal digital assistant (PDA) has multiple application processes. A speech recognition process takes input speech from a user and produces a recognition output representative of the input speech. A text-to-speech process takes output text and produces a representative speech output. A speech manager interface allows the speech recognition process and the text-to-speech process to be accessed by other application processes.

This application claims priority from U.S. provisional patent application 60/185,143, filed Feb. 25, 2000, and incorporated herein by reference.

### FIELD OF THE INVENTION

The invention generally relates to speech enabled interfaces for computer applications, and more specifically, to such interfaces in portable personal devices.

### BACKGROUND ART

A Personal Digital Assistant (PDA) is a multi-functional handheld device that, among other things, can store a user's daily schedule, an address book, notes, lists, etc. This information is available to the user on a small visual display that is controlled by a stylus or keyboard. This arrangement engages the user's hands and eyes for the duration of a usage session. Thus, many daily activities conflict with the use of a PDA, for example, driving an automobile.

Some improvements to this model have been made with the addition of third party speech recognition applications to the device. With their voice, the user can command certain features or start a frequently performed action, such as creating a new email or adding a new business contact. However, the available technology and applications have not done more than provide the first level of control. Once the user activates a shortcut by voice, they still have to pull out the stylus to go any further with the action. Additionally, users cannot even get to this first level without customizing the device to understand each command as it is spoken by them. These limitations prevent a new user from being able to control the device by voice when they open up their new purchase. They first must learn what features would be available if they were to train the device, and then must take the time to train each word in order to access any of the functionality.

### BRIEF DESCRIPTION OF THE DRAWINGS

The present invention will be more readily understood by reference to the following detailed description taken with the accompanying drawings, in which:

FIG. 1 illustrates functional blocks in a representative embodiment of the present invention.

FIGS. 2(a)-(d) illustrates various microphone icons used in a representative embodiment of the present invention.

FIG. 3 illustrates a speech preferences menu in a representative embodiment of the present invention.

### DETAILED DESCRIPTION OF SPECIFIC EMBODIMENTS

Embodiments of the present invention provide speech access to the functionalities of a personal digital assistant (PDA). Thus, user speech can supplement a stylus as an input device, and/or speech synthesis can supplement a display screen as an output device. Speaker independent word recognition enables the user to either compose a new email message, or to reply to an open email message, and to record a voice mail attachment. Since the system is speaker independent, the user does not have to first train the various speech commands. Previous systems used speaker dependent speech recognition to create a new email message and to allow recording voice mail attachments to email messages. Before such a system can be used, the user must spend time training the system and the various speech commands.

Embodiments also may include a recorder application that records and compresses a dictated memo. Memo files can be copied to a desktop workstation where they can be transcribed and saved as a note or in a word processor format such as for Microsoft Word. The desktop transcription application includes support for dictating email, scheduling appointments, adding tasks or reminders, and managing contact information. The transcribed text also can be copied to other desktop applications using the Windows clipboard.

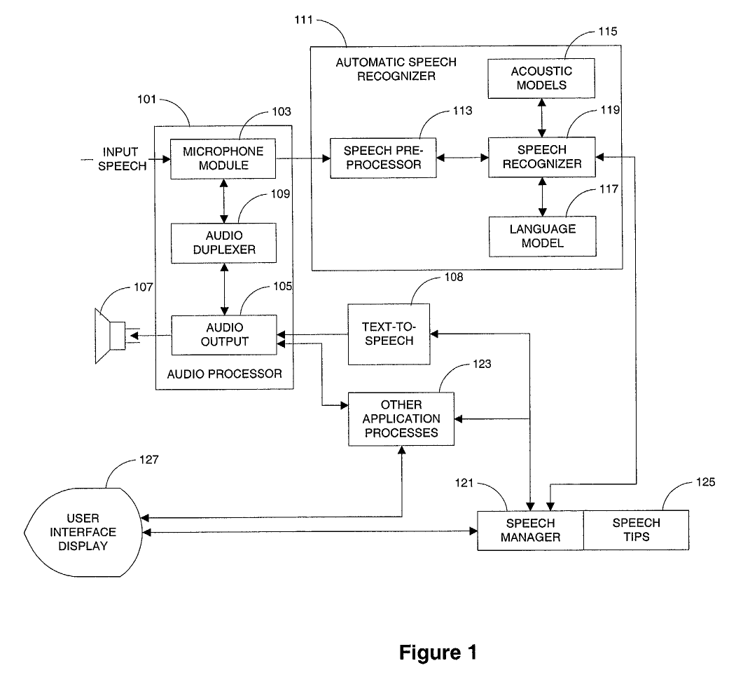

FIG. 1 shows the functional blocks in a typical PDA according to embodiments of the present invention. The speech manager 121 and speech tips 125 provide the improved speech handling capability and will be described in greater detail after initially discussing the other functional blocks. Typical embodiments include a PDA using the Win CE operating system. Other embodiments may be based on other operating systems such as the PalmOS, Linux, EPOC, BeOS, etc. A basic embodiment is intended to be used by one user per device. Support for switching between multiple user profiles may be included in more advanced embodiments.

An audio processor 101 controls audio input and output channels. Microphone module 103 generates a microphone input signal that is representative of a spoken input from the user. Audio output module 105 generates an audio output signal to an output speaker 107. The audio output signal may be created, for example, by text-to-speech module 108 that synthesizes text representative speech signals. Rather than an output speaker 107, the audio output signal may go to a line out, such as for an earphone or headphone adapter. Audio processor 101 also includes an audio duplexer 109 that is responsive to the current state of the device. The audio duplexer 109 allows half-duplex operation of the audio processor 101 so that the microphone module 103 is disabled when the device is using the audio output module 105, and vice versa.

An automatic speech recognition process 111 includes a speech pre-processor 113 that receives the microphone input signal from the microphone module 103. The speech pre-processor 113 produces a target signal representative of the input speech. Automatic speech recognition process 111 also includes a database of acoustic models 115 that each represent a word or sub-word unit in a recognition vocabulary. A language model 117 may characterize context-dependent probability relationships of words or subword units in the recognition vocabulary. Speech recognizer 119 compares the target signal from the speech pre-processor 113 to the acoustic models 115 and the language model 117 and generates a recognition output that corresponds to a word or subword unit in the recognition vocabulary.

The speech manager interface 121 provides access for other application processes 123 to the automatic speech recognition process 111 and the text-to speech application process 108. This extends the PDA performance to include advanced speech handling capability for the PDA generally, and more specifically for the other application processes 123. The speech manager interface 121 uses the functionality of the text-to-speech module 108 and the automatic speech recognition module 111 to provide dynamic response and feedback to the user's commands. The user may request specific information using a spoken command, and the device may speak a response to the user's query. One embodiment also provides a user setting to support visual display of any spoken information. When this option is set, the spoken input from the user, or the information spoken by an application, or both can be simultaneously displayed in a window on the user interface display 127.

The audio output module 105 also can provide an auditory cue, such as a beep, to indicate each time that the automatic speech recognizer 111 produces a recognition output. This is especially useful when the device is used in an eyes-off configuration where the user is not watching the user interface display 127. The auditory cue acts as feedback so that the user knows when the speech recognition module 111 has produced an output and is ready for another input. In effect, the auditory cues act to pace the speed of the user's speech input. In a further embodiment, the user may selectively choose how to configure such a feature, e.g., which applications to provide such a cue for, volume, tone, duration etc.

The speech tips module 125 can enable the speech manager 121 to communicate to the user which speech commands are currently available, if any. These commands may include global commands that are always available, or application-specific commands for one of the other applications 123, or both. Also, the speech tips may include a mixture of both speaker independent commands and speaker dependent commands.

The speech tips indication to the user from the speech tips module 125 may be an audio indication via the audio output module 105, or a visual indication, such as text, via the user interface display 127. The speech tips may also be perceptually subdivided for the user. For example, global commands that are always available may be indicated using a first perceptually distinctive characteristic, e.g., a first voice or first text appearance (bold, italics, etc.), while context-dependent commands may be indicated using a second perceptually distinctive characteristic, e.g., a second voice or second text appearance (grayed-out, normal, etc.). Such a feature may be user-configurable via a preferences dialog, menu, etc.

Before the present invention, no standard specification existed for audio or system requirements of speech recognition on PDAs. The supported processors on PDAs were on the low end of what is required for speech engine needs. Audio hardware, including microphones, codecs and drivers were not optimized for speech recognition engines. The audio path of previous devices was not designed with speech recognition in mind. Existing operating systems failed to provide an integrated speech solution for a speech application developer. Consequently, previous PDA devices were not adequately equipped to support developers who wanted to speech enable their application. For example, pre-existing industry APIs do not take into account the possibility that multiple speech enabled applications would be trying to use the audio input and output at the same time. This combination of industry limitations has been addressed by development of the speech manager 121. The speech manager 121 provides support for developers of speech enabled applications and addresses various needs and problems currently existing within the handheld and PDA industry.

There are also some common problems that a speech application faces when using ASR/TTS on its own, or that would be introduced if multiple applications each tried to independently use a speech engine on handheld and PDA devices. For example, these devices have a relatively limited amount of available memory, and relatively slower processors in comparison to typical desktop systems. By directly calling the speech engine APIs, each application loads an instance of ASR/TTS. If multiple applications each have a speech engine loaded, the amount of memory available to other software on the device is significantly reduced.

In addition, many current handheld devices support only half-duplex audio. If one application opens the audio device for input or output, and keeps the handle to the device open, then other applications cannot gain access to the audio channel for their needs. The first application prevents the others from using the speech engines until it releases the hold on the device.

Another problem is that each speech client application would have to implement common features on its own, causing code redundancy across applications. Such common features include:

managing the audio system on its own to implement use of the automatic speech recognition process 111 or the text-to-speech module 108 and the switching between the two,

managing common speaker independent speech commands on its own,

managing a button to start listening for speech input commands, if it even implements it, and

managing training of user-dependent words.

The speech manager 121 provides any other application process 123 that is speech enabled, with programming interfaces so that the developers can independently use speech recognition, or text-to-speech as part of the application. The developers of each application can directly call to the speech APIs. Thus, the speech manager 121 handles the automatic speech recognition process 111 and the text-to-speech module 108 for each application on a handheld or PDA device. There are significant benefits to having one application such as the speech manager 121 handling the text-to-speech module 108 and the automatic speech recognition process 111 for several clients:

centralized speech input and output to reduce the complexity of the client application,

providing a common interface for commands that are commonly used by all applications, for example, speech commands like “help” or “repeat that”,

providing a centralized method to select preferred settings that apply to all applications, such as the gender of the TTS voice, the volume, etc.,

managing one push-to-talk button to enable the automatic speech recognition process 111 to listen for all speech applications (reducing the power drawn by listening only when the button is pressed; reducing possible false recognition by listening only when the user intends to be heard; reducing clutter because each client application doesn't have to implement its own press-to-talk button; and pressing the button automatically interrupts the text-to-speech module 108, allowing the user to barge-in and be heard),

providing one place to train or customize words for each user, and

providing common features to the end user that transcend the client application's implementation (e.g., store the last phrase spoken, regardless of which client application requested it, so that the user can say “repeat that” at any time to hear the text-to-speech module 108 repeat the last announcement; and,

providing limited monitoring of battery status on the device and restricting use of the automatic speech recognition process 111 or the text-to-speech module 108 if the battery charge is too low).

In addition, specific graphical user interface (GUI) elements are managed to provide a common speech user interface across applications. This provides, for example, a common GUI for training new speaker dependent words. This approach also provides a centralized method for the user to request context sensitive help on the available speech commands that can be spoken to the device. The help strings can be displayed on the screen, and/or spoken back to the user with the text-to-speech module 108. This provides a method by which a client application can introduce their help strings into the common help system. As different client applications receive the focus of the speech input, the available speech commands will change. Centralized help presents a common and familiar system to the end user, regardless of which client application they're requesting help from.

The speech manager 121 also provides the implementation approach for the speech tips module 125. Whenever the user turns the system microphone on, the speech tips module 125 directs the user interface display 127 to show all the available commands that the user can say. Only the commands that are useable given the state of the system are presented. The speech tips commands are presented for a user configurable length of time.

One specific embodiment is based on a PDA running the WinCE operating system and using the ASR 300 automatic speech recognizer available from Lernout & Hauspie Speech Products, N.V. of leper, Belgium. Of course, other embodiments can be based on other specific arrangements and the invention is in no way limited to the requirements of this specific embodiment.

In this embodiment, the automatic speech recognition process 111 uses a set of acoustic models 115 that are pre-trained, noise robust, speaker independent, command acoustic models. The term “noise robust” refers to the capacity for the models to operate successfully in a complex acoustic environment, i.e., when driving a car. The automatic speech recognition process 111 has a relatively small footprint—for a typical vocabulary size of 50 words, about 200 Kbytes flash for the words, 60 Kbytes for program code, and 130 Kbytes RAM, all of which can run on a RISC (e.g. Hitachi SH3) at 20 MIPS. The automatic speech recognition process 111 uses discrete density-based hidden Markov models (HMMs) system. Vector quantizing (VQ) codebooks and the HMM acoustic models are made during a training phase.

During the training phase, the HMM acoustic models 115 are made noise robust by recording test utterances with speakers in various acoustic environments. These acoustic environments include a typical office environment, and an automobile in various conditions including standing still, medium speed, high speed, etc. Each word in the recognition vocabulary is uttered at least once in a noisy condition in the automobile. But, recording in an automobile is time consuming, costly, and dangerous. Thus, the vocabulary for the car recordings is split up in three parts of equal size, 2 out of the 3 parts are uttered in each acoustic condition, creating 6 possible sequences. This has been found to provide essentially the same level of accuracy as when recording all words in all 3 conditions, or with all speakers in car. By using a mixture of office and in-car recordings, the acoustic models 115 are trained which work in both car and office environments. Similar techniques may be used with respect to the passenger compartment of an airplane. In another embodiment, acoustic background samples from various environments could be added or blended with existing recordings in producing noise robust acoustic models 115.

The speech pre-processor 113 vector quantizes the input utterance using the VQ codebooks. The output vector stream from the speech pre-processor 113 is used by the speech recognizer 119 as an input for a dynamic programming step (e.g., using a Viterbi algorithm) to obtain a match score for each word in the recognition vocabulary.

The speech recognizer 119 should provide a high rejection rate for out of vocabulary words (e.g., for a cough in the middle of a speech input). A classical word model for a non-speech utterance can use an HMM having uniform probabilities: P(Ok¦Sij)=1/Nk, with Ok the observation (k=0 . . . K−1), and P(Ok¦Sij) the probability of seeing this observation Ok at state transition ij. Another HMM can be made with all speech of a certain language (all isolated words) mapped onto a single model. A HMM model can also made with real “non-vocabulary sounds” in a driving car. By activating these non-speech models in the test phase next to the word models of the active words, the speech recognizer 119 obtains a score for each model, and can get recognition or rejection of a given model based on the difference in scores of the best ‘non-speech model’ and the best word model:

GS-WS<Tw=>rejection

GS-WS>Tw=>acceptance,

where GS-WS is the greatest scoring word score, and Tw is a word-dependent threshold. Where the scores are (−log) probability, the lower the threshold, the higher the rejection. Increasing the threshold, decreases the number of false acceptances and increases the rate of false rejections (some substitution errors might get ‘masked’ by false rejections). To optimize the rejection rate, the word dependent thresholds are fine-tuned based on the set of active words, thereby giving better performance on rejection.

The automatic speech recognition process 111 also uses quasi-continuous digit recognition. Compared to full continuous digit recognition, quasi-continuous digit recognition has a high rejection rate for out of vocabulary words (e.g. cough). Moreover, with quasi-continuous digits, the user may have visual feedback on the user interface display 127 for immediate error correction. Thus, when a digit is wrongly recognized, the user may say “previous” and repeat it again.

The following functionality is provided without first requiring the user to train a spoken command (i.e., the automatic speech recognition process 111 is speaker independent):

Retrieve, speak and/or display the next scheduled appointment.

Retrieve, speak and/or display the current day's scheduled appointments and active tasks.

Lookup a contact's phone number by spelling the contact name alphabetically.

Once the contact is retrieved, the contact's primary telephone number can be announced to the user and/or displayed on the screen. Other telephone numbers for the contact can be made available if the user speaks additional commands. An optional feature can dial the contact's phone number, if the PDA supports a suitable application programming interface (API) and hardware that the application can use to dial the phone number.

Retrieve and speak scheduled appointments by navigating forwards and backwards from the current day using a spoken command.

Preview unread emails and announce the sender and subject of each e-mail message in the user's inbox.

Create a reply message to the email that is currently being previewed. The user may reply to the sender or to all recipients by recording a voice wave file and attaching it to the new message.

Announce current system time upon request. The response can include the date according to the user's settings.

Repeat the last item that was spoken by the application.

The application can also monitor the user's schedule in an installed appointments database, and provide timely notification of an event such as an appointment when it becomes due. The application can set an alarm to announce at the appropriate time the appointment and its description. If the device is turned off, the application may wake up the device to speak the information. Time driven event notifications are not directly associated with a spoken input command, and therefore, the user is not required to train a spoken command to request event notification. Rather, the user accesses the application's properties pages using the stylus to set up event notifications.

The name of an application spoken by the user can be detected, and that application may be launched. The following applications can be launched using an available speaker independent command. Additional application names can be trained through the applications training process.

“contacts”—Focus switches to a Contact Manager, where the user can manage Address book entries using the stylus and touch screen.

“tasks”—Focus switches to a Tasks Manager, where the user can manage their active tasks using the stylus and touch screen.

“notes”—Focus switches to a Note Taker, where the user can create or modify notes using the stylus and touch screen.

“voice memo”—Focus switches to a voice memo recorder, where the user can manage the recording and playback of memos.

“calendar”—Focus switches to a Calendar application, where the user can manage their appointments using the stylus and touch screen.

“inbox”—Focus switches to an Email application, where the user can manage the reading of and replying to email messages.

“calculator”—Focus switches to a calculator application, where the user can perform calculations using the built-in calculator application of the OS.

Some users having learned the standard built-in features of a typical embodiment, may be willing to spend time to add to the set of commands that can be spoken. Each such added command will be specific to a particular user's voice. Some additional functionality that can be provided with the use of speaker dependent words includes:

Lookup a contact by name. Once the contact is retrieved, their primary telephone number will be announced. The user must individually train each contact name to access this feature. Other information besides the primary telephone number (alternate telephone numbers, email or physical addresses) can be provided if the user speaks additional command words. An option may be supported to dial the contact's telephone number, if the device supports a suitable API and hardware that can be used to dial the telephone number.

Launch or switch to an application by voice. The user must individually train each application name. This feature can extend the available list of applications that can be launched to any name the user is willing to train. Support for switching to an application will rely on the named application's capability to detect and switch to an existing instance if one is already running. If the launched application does not have this capability, then more than one instance will be launched.

As previously described, the audio processor 101 can only be used for one purpose at a time (i.e., it is half-duplex); either it is used with a microphone, or with a speaker. When the system is in the text-to-speech mode, it cannot listen to commands. Also, when the microphone is being used to listen to commands, it cannot be used for recording memos. In order to reduce user confusion, the following conventions are used.

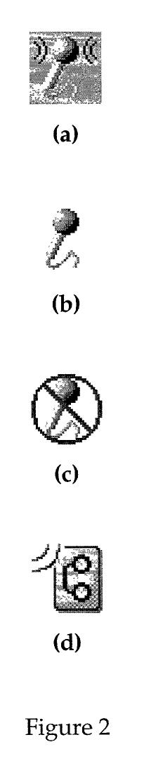

The microphone may turned on by tapping on a microphone icon in a system tray portion, or other location of the user interface display 127, or by pressing and releasing a microphone button on the device. FIGS. 2(a)-(d) illustrates various microphone icons used in a representative embodiment of the present invention. The microphone icon indicates a “microphone on” state by showing sound waves on both sides of the microphone icon, as shown in FIG. 2(a). In addition, the microphone icon may change color, e.g., to green. In the “microphone on” state, the device listens for commands from the user. Tapping the microphone icon again turns the microphone off (or pressing and releasing the microphone button on the left side of device). The sound wave images around the microphone icon disappear, shown in FIG. 2(b). In addition, the icon may change color, e.g., to gray. The microphone is not available, as shown in FIG. 2(c), any time that speech is not an option. For example, any time that the user has opened and is working in another application that uses the audio channel, the microphone is unavailable. The user can “barge in” by tapping the microphone icon, or pressing the microphone button. This turns off the text-to-speech module 108 and turns on the microphone icon. As shown in FIG. 2(d), the microphone icon changes to a recorder icon when recording memos or emails.

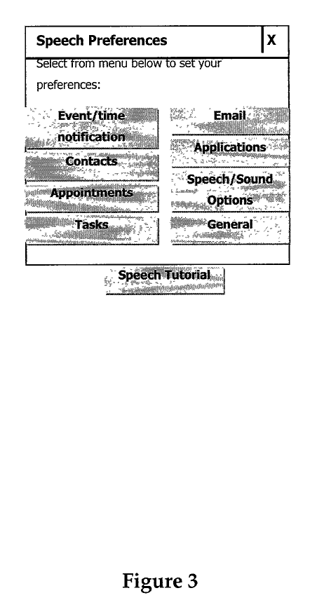

There are many options that the user can set in a speech preferences menu, located at the bottom of a list activated by the start button on the lower left of the user interface display 127, as shown for example in FIG. 3. The microphone is unavailable while in the speech preferences setup menu, entries may be done with a virtual keyboard using a stylus. Opening the speech preferences setup menu automatically pops up the virtual keyboard if there is data to be entered.

The speech preferences setup menu lets the user set event notification preferences. Event notification on/off spoken reminder [DEFAULT=OFF] determines whether the device provides a spoken notification when a specified event occurs. In addition, the user may select types of notifications: appointment time has arrived, new email received, etc. When this option is on, the user can push the microphone button in and ask for “MORE DETAIL”. There is no display option for event notification because of potential conflicts with the system and other application processes 123, and the potential for redundant visual notification of information that is already displayed by one of the other application processes 123. Event notification preferences also include whether the date is included in the time announcement [DEFAULT=Yes]. Also, a “learn more” button in the preferences dialogue box brings up a help screen that gives more details of what this screen does.

The speech preferences setup menu also allows the user to set appointment preferences such as whether to announce a description [DEFAULT=ON], whether to announce location [DEFAULT=OFF], whether to announce appointments marked private [DEFAULT=OFF], and to set NEXT DAY preferences [DEFAULT=Weekdays only] (other options are Weekdays plus Saturday, and full 7-day week).

The Contacts list contains all contacts, whether trained or not, with the trained contacts on top of the list, and the untrained contacts in alphabetical order on the bottom on the list. “Train” launches a “Train Contact” function to train a contact. When training is complete, the name moves from the bottom to the top of the list. “Remove” moves the application name from the top of the list to the bottom of the list and deletes the stored voice training for that contact. The bottom of the list is automatically in alphabetical order. The top of the list is in order of most recently added on top, until the user executes “Sort.”

A memo recorder for automatic speech recognition may be launched using a call to function ShellExecuteEx( ) with command line parameters that specify path and file name to write to, file format (e.g., 8 bit 8 KHz PCM or compressed), and Window handle to send the message to when done. A wparam of the return message could be a Boolean value indicating if the user accepted (“send”) or cancelled the recorded memo. If the recorder is running, this information may be passed to the running instance. The path and file to write to are automatically supplied, so the user should not be able to select a new file, otherwise, a complete audio file may not be generated when the user is done. There may also be other operations that are not appropriate during use of the memo recorder.

When the user says “send” or “cancel”, the recorded file should be saved or deleted, respectively. A Windows message is sent to the handle provided indicating the user's choice. A COM object provides a function, RecordingMode( ), to inform the Speech Manager 121 that the microphone module 103 will be in use. In the case of recording mode, the calling application will be notified of the microphone button being pressed (function MicButtonPressed( )). This prevents audio collisions between these applications.

The speech manager 121 has various internal modules. An engine manager module manages the automatic speech recognition process 111 and the text-to-speech module 108 engine instances, and directs interactions between the speech manager 121, the automatic speech recognition process 111, and the text-to-speech module 108. An action manager module handles recognition events that are to be used internally to the speech manager 121. Such events are not notified to a particular client application. This includes taking the action that corresponds to the recognition of a common word. A dialogue manager module manages the activation and deactivation of different speech recognition process 111 grammars by the speech manager 121. This includes ownership of a grammar, and notifying the appropriate other application process 123 when a word is recognized from that client's activated grammar. The dialog manager module also manages the interaction between the automatic speech recognition process 111 and the text-to-speech module 108, whether the speech manager 121 is listening or speaking.

An event manager module manages the notification of events from the automatic speech recognition process 111 and the text-to-speech module 108 to a communications layer COM object internal to the speech manager 121. The COM object module includes some WinCE executable code, although, as noted before, other embodiments could use suitable code for their specific operating environment.

The speech manager executable code manages all aspects of the automatic speech recognition process 111 and the text-to-speech module 108 in a reasonable way to avoid audio usage collisions, and insures that the other application processes 123 interact in a consistent manner. Only one running instance of each the automatic speech recognition process 111 and the text-to-speech module 108 speech engine is allowed. Both the client COM object and the control panel applet communicate with this TTS/ASR Manager Executable. For the most part, this executable remains invisible to the user.

The executable module also manages grammars that are common to all applications, and manages engine-specific GUI elements that are not directly initiated by the user. The audio processor 101 is managed for minimal use to conserve power usage. Notifications that are returned to the caller from this manager executable module are asynchronous to avoid the client from blocking the server executable. The executable also provides for a graphical display the list of words that may be spoken during user-initiated ASR commands, using the speech tips 125. The executable also allows a client executable to install and uninstall word definition files which contain the speaker independent data needed to recognize specific words.

The executable portion of the speech manager 121 also manages GUI elements on the user interface display 127. The user may train words to be added to the system based on a dialog that is implemented in the speech manager executable. While the speech manager 121 is listening, the executable displays on the user interface display 127 a list of words that may be spoken from the speech tips module 125. Context-sensitive words can be listed first, and common words listed second. Similarly, a spelling tips window may also be displayed for when the user initiates spelling of a word. This displays the list of the top words that are likely matches, the most likely being first. The executable also controls a help window on the user interface display 127. When the user says “help”, this window, which looks similar to the speech tips window, provides details on what the commands do. In another embodiment, help may also be available via audio output from the text-to-speech module 108.

The speech manager executable may also address a device low battery power condition. If the device is not plugged-in and charging (i.e., on battery-only power), and a function call to GetSystemPowerStatusEx( ) reports main battery power percentage less than 25%, the use of both the automatic speech recognition process 111 and the text-to-speech module 108 can be suspended to conserve battery life until the device is recharged. This is to address the fact that the audio system uses a significant amount of battery power.

The speech manager executable also controls interaction between the automatic speech recognition process 111 and the text-to-speech module 108. If the text-to-speech module 108 is speaking when the microphone button is pressed, the text-to-speech module 108 is stopped and the automatic speech recognition process 111 starts listening. If the automatic speech recognition process 111 is listening when the text-to-speech module 108 tries to speak, the text-to-speech module 108 requests will be queued and spoken when the automatic speech recognition process 111 stops listening. If the text-to-speech module 108 tries to speak when the output audio is in use by another application, attempts to speak will be made every 15 seconds by the executable for an indefinite period. Each time text is sent to the text-to-speech module 108, the battery power level is checked. If it is below the threshold mentioned above, a message box appears. The text-to-speech module 108 request may be made without the users invoking it, such as an alarm. Therefore, this message box appears only once for a given low power condition. If the user has already been informed of low power conditions after pressing the microphone button, the message won't appear at all. The text-to-speech module 108 entries will remain in the queue until sufficient power is restored.

The control panel applet module of the speech manager 121 manages user-initiated GUI elements of the TTS/ASR manager executable. Thus, the applet manages a set of global user defined settings applicable to the text-to-speech module 108 and the automatic speech recognition process 111, and manages access to the trained words dialog. The control panel applet uses a user settings control panel dialog box. These settings are global to all the speech client applications. Default TTS-related attributes controlled by the applet include voice (depending on the number of voices supplied), volume, pitch, speed, and sound for “alert” speech flag to get user's attention before the text-to-speech module 108 speaks. Default ASR-related attributes controlled by the applet include the sound used to alert the user that the automatic speech recognition process 111 has stopped listening, a noisy environment check box (if needed) that allows the user to select between two different threshold levels, a program button (if needed), access to the trained words dialog implemented in manager executable, whether to display Speech/Spell Tips as the user speaks commands, length of time to display SpeechTips, and length of time the automatic speech recognition process 111 listens for a command.

All settings except user-trained words are stored in the registry. When the user presses the “apply” button, a message is sent to the speech manager 121 to “pick up” the new settings.

The communication layer COM object module provides an interface between each client application process and the speech manager 121. This includes the method by which the client application connects and disconnects from the speech manager 121, activates grammars in the automatic speech recognition process 111, and requests items to be spoken by the text-to-speech module 108. The speech client COM object makes requests to speak and activate grammars, among other things. The COM object also provides a collection of command functions to be used by client applications, and has the ability to register a callback function for notifications to call into client application object. No direct GUI elements are used by the COM object.

The COM object provides various functions and events as listed and described in Tables 1-6:

TABLE 1
COM Object General Functions

| Function | Purpose |
|---|---|
| GetVersionInfo | Ask yes/no questions about the features |
| | available. These questions are in the form of |
| | integers. TRUE or FALSE is returned. See |
| | notes below for details. |
| Connect/Disconnect | Initiates the communication with the Manager |
| | Executable. Connect includes the notification |
| | sink for use by C++ applications. Visual Basic |
| | programs use the event system. The parameter |
| | is a string identifying the application. |
| | Errors(s): Cannot connect, out-of-memory |
| GetLastError | Gets the error number and string from the most |
| | recent function. Error(s): Not connected |
| RegisterEventSink | Takes a pointer to event sink and a GUID |
| | of the event sink |
| GetTTS | Get the inner TTS object that contains the |
| | TTS functionality. Error(s): Cannot connect, |
| | no interface |
| GetAsr300 | Get the inner Asr300 object that contains the |
| | ASR functionality. Error(s): Cannot connect, |
| | no interface |
| RecordingMode | Allows application to use audio input. Speech |
| | manager can react accordingly by sending the |
| | MicButtonPressed() event to the application. |
| | Error(s): Not connected, Already in use |
| DisplayGeneralSettings | Displays control panel for speech manager. |
| | Error(s): Not connected |

TABLE 2
COM Object General Events

| Function | Purpose |
|---|---|
| MicButtonPressed | The user pressed the microphone button. This is |
| | returned only to the application that called |
| | RecordingMode() to control input. In this case, |
| | Speech Manager automatically exits recording mode |
| | and regains control of mic. button. |

TABLE 3
COM Object TTS-Related Functions

| Function | Purpose |
|---|---|
| GetVersionInfo | Ask yes/no questions about the features available. |
| | These questions are in the form of integers. TRUE |
| | or FALSE is returned. See notes below for details. |
| Speak | The text to speak is provided as input. The voice, |
| | preprocessor and flags are also inputs. An ID for |
| | the text to be spoken is returned. Flags provide the |
| | intent of the message, either normal or alert. An |
| | alert plays a sound that gets the user's attention. |
| | Error: Cannot connect, out-of-memory |
| GetVoiceCount | Get number of voices that are available |
| | Error(s): Cannot connect |
| GetVoice | Get name of voice that are available by index |
| | Error(s): Cannot connect |
| DisplayText | Property. Boolean. Returns true if user desired to see |
| | a display of data. |
| SpeakText | Property. Boolean. Returns true if user desired to hear |
| | data spoken out loud. |

TABLE 4
COM Object TTS-Related Events

| Function | Purpose |
|---|---|
| Spoken | Returned is the ID of the text that was spoken and cause |
| | of the speech stopping (normal, user interruption or |
| | system error). |
| RepeatThat | Returned is the ID of the text that was repeated so that |
| | the application can choose the text that should be |
| | displayed. This is only sent if the user chose to display |
| | data. This allows an application to redisplay data |
| | visually. |

TABLE 5
COM Object ASR-Related Functions

| Function | Purpose |
|---|---|
| GetVersionInfo | Ask yes/no questions about the features available. |
| | These questions are in the form of integers. |
| | TRUE or FALSE is returned. See notes below |
| | for details. |
| LoadGrammar | Adds a grammar file to list of grammars. The path |
| | to the file is the only input. A grammar ID is the |
| | output. This grammar is unloaded when client |
| | application disconnects. Error(s): Cannot connect, |
| | out-of-memory, invalid file format, duplicate |
| | grammar |
| UnloadGrammar | Removes a grammar file from list of grammars. |
| | The grammar ID is the only input. |
| | Error(s): Cannot connect, invalid grammar |
| AddWord | One input is the ID of the grammar to add the |
| | word. A second input is the name of the rule. |
| | Another input is the word to add. Error(s): Cannot |
| | connect, out-of-memory, invalid grammar, |
| | grammar active, duplicate word |
| RemoveWord | One input is the ID of the grammar to remove the |
| | word. A second input is the name of the rule. |
| | Another input is the word to remove. Error(s): |
| | Cannot connect, out-of-memory, invalid grammar, |
| | word active, word not found |
| ActivateRule | Activates the rule identified by the grammar ID |
| | and rule name Error(s): Cannot connect, out-of- |
| | memory, invalid grammar, too many active words |
| ActivateMainLevel | Activates the main grammar level. This, in effect, |
| | deactivates the sublevel rule. |
| | Error(s): Cannot connect, out-of-memory |
| TrainUserWord | Brings up a GUI dialog. An optional input is the |
| | user word to be trained. Another optional input is |
| | description text for the input word page. |
| | Error(s): Cannot connect, out-of-memory |
| InstallWordDefs* | Input is the path to the word definition file to |
| | install Error(s): Cannot connect, out-of-memory, |
| | file not found, invalid file format? |
| UnInstallWordDefs* | The input is the uninstall word definition file |
| | Error(s): Cannot connect, out-of-memory, file not |
| | found, invalid file format? |
| GetUserWords | Returns a list of words that the user has trained on |
| | device Error(s): Cannot connect, out-of-memory |
| SpellFromList | Begins spelling recognition against a list of words |
| | provided by the client application. The spelling |
| | grammar is enabled. This user may say letters |
| | (spell), say “search”, “reset” or “cancel”. Error(s): |
| | Cannot connect, out-of-memory |
| StopListening | Stops listening for user's voice. This may be |
| | called when the application gets the result it needs |
| | and has no further need for input. Error(s): |
| | Cannot connect |
| RemoveUserWord | Removes the provided user trained word from the |
| | list of available user words. Error(s): Cannot |
| | connect, out-of-memory, word active, word not |
| | found |

*For ASR 300 only

TABLE 6
COM Object ASR-Related Events

| Function | Purpose |
|---|---|
| RecognitionResult | This event is sent when there is recognition result |
| | for the client object to process. Returned is the ID |
| | of the grammar file that contained the word, the |
| | rule name and the word string. Also returned is a |
| | flag indicating the purpose, that is, a command |
| | or user requested help. This is sent to the object |
| | that owns the grammar rule. |
| MainLevelSet | This function is called when the main menu is set. |
| | This allows a client program to reset its state |
| | information. This is sent to all connected |
| | applications. |
| SpellingDone | Returns the word that was most likely spelled. |
| | If no match was found, it returns a zero length |
| | string. This is sent to the object that initiated |
| | spelling. The previously active grammar will be |
| | re-activated. |
| UserWordChanged | Informs of a user word being added or deleted. |
| | The application may take the appropriate action. |
| | This is sent to all connected applications. |
| TrainingDone | Returns a code indicating training of a new |
| | user word was completed or aborted. This is sent |
| | to the object that started the training. |

Each ASR grammar file contains multiple rules. A rule named “TopLevelRule” is placed at the top-level and the others are available for the owner (client) object to activate.

The GetVersionInfo( ) function is used to get information about the features available. This way, if a version is provided that lacks a feature, that would be known. The input is a numeric value representing the question “do you support this?” The response is TRUE or FALSE, depending on the availability of the feature. For example, the text-to-speech module 108 object could pass a value 12, for example, which is asking if the text-to-speech module 108 supports an e-mail preprocessor. It is then possible for a client application to tailor its behavior accordingly.

The various processes, modules, and components may use Windows OS messages to communicate back and forth. For some data transfer, a memory-mapped file is used. The speech manager executable has one invisible window, as does each COM object instance, which are uniquely identified by their handle. Table 7 lists the types of messages used, and the ability of each message:

TABLE 7
Windows Messaging

| Type of Message | What It Can Do |
|---|---|
| User Messages | Send two integer values to the destination window. |
| (WM_USER) | The values are considered by the destination |
| | window to be read-only. This method is useful if |
| | only up to two integers need to be transferred. |
| WM_COPYDATA | Send a copy of some data block. The memory in |
| | the data block is considered by the destination |
| | window to be read-only. There is no documented |
| | size limitation for this memory block. This method |
| | is useful if copy of memory needs to be transferred. |
| Memory Mapped | There is shared memory used by the COM object |
| Files | and the Speech Manager Executable. This is the |
| | only method of the three that permits reading and |
| | writing by the destination window. Access to the |
| | read-write memory area is blocked by a named |
| | mutex (mutually exclusive) synchronization object, |
| | so that no two calls can operated on the shared |
| | memory simultaneously. With in the block, a user |
| | message initiates the data transfer. The size of this |
| | shared memory is 1K bytes. This method is useful if |
| | information needs to be transferred both directions |
| | in one call. |

Tables 8-14 present some sample interactions between the speech manager 121 and one of the other application processes 123.

TABLE 8
Basic client application

| When client application does . . . | Speech Manager does . . . |
|---|---|
| Create Speech Manager automation object | |
| Call Connect() | |
| | Adds the object to a list |
| | of connected objects |
| Do stuff | |
| Call Disconnect() | |
| | Removes the object from a |
| | list of connected objects |
| Release automation object | |

TABLE 9
Basic client application with speech

| When client application does . . . | Speech Manager does . . . |
|---|---|
| Create Speech Manager automation | |
| object (as program starts) | |
| Call Connect() | |
| | Adds the object to a list of |
| | connected objects |
| Later, call Speak() with some text | |
| | Added text to queue and returns |
| | Start speaking |
| | When speaking is done, |
| | Spoken() event is sent to the |
| | application that requested the |
| | speech. |
| Handles the Spoken() event, if desired | |
| Call Disconnect() (as program exits) | |
| | Removes the object from a list |
| | of connected objects |
| Release automation object | |

TABLE 10
Basic client application with recognition

| When client application does . . . | Speech Manager does . . . |
|---|---|
| Create Speech Manager automation object | |
| (as program starts) | |
| Call Connect( ) | |
| | Adds the object to a list of connected objects |
| Call LoadGrammar( ). Let's say that | |
| the <start> rule | |
| contains only the word “browse” and the | |
| <BrowseRule> contains “e-mail”. | |
| | Load the rule and words and note that this client |
| | application owns them |

Later the user presses the microphone button and says “browse”

| | |
|---|---|
| | The RecognitionResult( ) event is sent to this client |
| | application |
| Handles the RecognitionResult( ) event for “browse” | |
| Call ActivateRule( ) for <BrowseRule> | |
| | Activates <BrowseRule> |

The user says “e-mail”

| | |
|---|---|
| Handles the RecognitioniResult( ) event for “e-mail” | |
| Do something appropriate for e-mail | |
| Call Disconnect( ) (as program exits) | |
| | Removes the object from a list of connected objects |
| Release automation object | |

TABLE 11
Spelling “Eric” completely

| When client application does . . . | Speech Manager does . . . |
|---|---|
| Call SpellFromList( ) providing a list words to spell | |
| against “Edward”, “Eric” and “Erin” | |
| | Speech manager initiates spelling mode, returns |
| | from call to client application |
| | Optional GUI SpellingTips window appears |

User says “E”, results come back internally, displays “Edward” “Erin” and “Eric”
User says “R”, results come back internally, displays “Erin”, “Eric” (and “Edward”?)
User says “I”, results come back internally, displays “Erin”, “Eric” (“Edward”?)
User says “C”, results come back internally, displays “Eric” (“Erin” and “Edward”?)
User says “Search” (“Verify”), SpellingDone( ) event sent to client application providing
“Eric” and the optional GUI SpellingTips window disappears

| | |
|---|---|
| | Previous active rule re-activated |
| Handles SpellingDone( ) event using “Eric” | |

TABLE 12
Spelling “Eric” incompletely

| When client application does . . . | Speech Manager does . . . |
|---|---|
| Call SpellFromList( ) providing a list of words to | |
| spell against “Edward”, “Eric” and “Erin” | |
| | Speech manager initiates spelling mode, returns |
| | from call to client application |
| | Optional GUI SpellingTips window appears |

User says “L”, results come back internally, displays “Edward”, “Erin” and “Eric”
User says “R”, results come back internally, displays “Erin”, “Eric” (and “Edward”?)
User says “I”, results come back internally, displays “Erin”, “Eric” (and “Edwards”?)
User says “Search” (“Verify”), SpellingDone( ) event sent to client application providing “Erin”
or “Eric” (whichever is deemed most likely). In this case, it could be either word.
The optional GUI SpellingTips window disappers

| | |
|---|---|
| | Previously active rele re-activated |
| Handles SpellingDone( ) event using “Eric” or | |
| “Erin” | |

TABLE 13
A representative embodiment usage of record audio (This part doesn't directly involve
the speech manager. It is here for clarity.)

| When client application does . . . | Speech Manager does . . . |
|---|---|
| A representative embodiment launches recorder | |
| application with command line switches to | |
| provide information (format, etc.) | |
| | Starts WinCE Xpress Recorder with path to file |
| | to record to and the audio format |
| | When recording is done, a Windows message is |
| | sent to A representative embodiment. This |
| | message specifies if the user pressed Send or |
| | Cancel. |
| Handles the Windows message | |
| Reactivate the proper rule | |

TABLE 14
Memo Recorder usage of Speech Manager

| When client application does . . . | Memo Recorder does . . . |
|---|---|
| Call LoadGrammar( ). Let's say that the | |
| <RecordRule> rule contains the words “record” | |
| and “cancel”. The <RecordMoreRule> contains | |
| “continue recording” and “send” and “cancel”. | |
| There is no <start> rule needed. | |
| | Loads that grammar file |
| Call ActivateRule( ) for <RecordRule> | |
| | Activates <RecordRule> |

Later, the user presses the microphone button and says “record” to start recording

| | |
|---|---|
| | The RecocitionResult( ) event is sent to this |
| | WinCE Xpress Recorder for “record” |
| Handles the RecognitionResult( ) event for | |
| “record”. | |
| Call ActivateRule( ) for <RecordMoreRule>, since | |
| there will be something recorded. | |
| | Activates <RecordMoreRule> |
| Call RecordMode(TRUE). | |
| | Enters recording mode. Next time microphone |
| | button is pressed, it notifies the client application |
| | (in this case, WinCE Xpress Recorder). |
| Begins recording. | |

Later, the user presses microphone button to stop recording

| | |
|---|---|
| | The MicButtonPressed( ) event is sent to this |
| | client application. Record mode is reset to idle |
| | state. |
| Handles the MicButtonPressed( ) event. | |
| Stop recording. If the graphical button was | |
| pressed instead of microphone button, | |
| RecordMode(FALSE) would need to be called. | |

Later, the user presses microphone button and says “continue recording”

| | |
|---|---|
| | The RecognitionResult( ) event is sent to this |
| | WinCE Xpress Recorder for “continue recording” |
| Handles the RecognitionResult( ) event for | |
| “continue record”. | |
| Call RecordMode(TRUE). | |
| | Enters recording mode (same as before). |
| Begins recording. | |

Later, the user presses microphone button to stop recording

| | |
|---|---|
| | The MicButtonPressed( ) event is sent to this |
| | client application. Record mode is reset to idle |
| | state. |
| Handles the MicButtonPressed( ) event. | |
| Stop recording. | |

Later, the user presses microphone button and says “send”

| | |
|---|---|
| | The RecognitionResult( ) event is sent to this |
| WinCE Xpress Recorder for “send” | |
| Handles the RecognitionResult() event for | |
| “send”. | |
| Saves the audio file. If “cancel” was spoken, the | |
| file should be deleted. | |
| Sends a Windows message directly to the A | |
| representative embodiment executable | |
| specifying that the user accepted recording. | |
| WinCE Xpress Recorder closes. | |

What is claimed is:

1. A handheld electronic device having automatic speech recognition, the device comprising:
a. a speech pre-processor that receives input speech and produces a target signal representative of the input speech;
b. a database of speaker independent acoustic models, each acoustic model representing a word or subword unit in a recognition vocabulary, each acoustic model being representative of its associated word or subword unit as spoken in a plurality of acoustic environments; and
c. a speech recognizer that compares the target signal to the acoustic models and generates a recognition output of at least one word or subword unit in the recognition vocabulary representative of the input speech.

2. A handheld electronic device according to claim 1, further including:
d. a language model that characterizes context-dependent probability relationships of words in the recognition vocabulary, wherein the speech recognizer compares the target signal to the acoustic models and the language model to generate the recognition output.

3. A handheld electronic device according to claim 1, wherein the plurality of acoustic environments includes a first acoustic environment and a second acoustic environment, the second acoustic environment having more background noise than the first acoustic environment.

4. A handheld electronic device according to claim 3, wherein the second acoustic environment is the passenger compartment of an automobile or airplane.

5. A handheld electronic device according to claim 1, wherein the database further includes acoustic models for non-word sounds, and no recognition output is generated when the speech recognizer determines that a non-word sound acoustic model represents the input speech.

6. A handheld electronic device according to claim 1, wherein the device further includes a user interface output module that communicates information to a user.

7. A handheld electronic device according to claim 6, wherein the user interface output module includes a user interface display that displays text to the user, the text being representative of the recognition output.

8. A handheld electronic device according to claim 6, wherein the user interface output module includes an audio output module that generates audio output for communication to the user.

9. A handheld electronic device according to claim 8, wherein the audio output module generates an audio cue output for the user each time the speech recognizer generates a recognition output.

10. A handheld electronic device according to claim 8, further comprising:
e. a text-to-speech application that processes output text, and produces a representative speech output to the audio output module.

11. A handheld electronic device according to claim 10, further comprising:
f. a speech manager interface that allows the speech recognizer and the text-to-speech application to be accessed by other applications, so as to prevent more than one instantiation of the speech recognizer and one instantiation of the text-to-speech application at any given time.

12. A handheld electronic device according to claim 11, wherein the speech manager interface further includes a dialog manager that manages a plurality of speech recognition grammars, each grammar being associated with at least one application, the dialog manager selecting a current recognition grammar for the speech recognizer, the current recognition grammar being associated with a currently selected application.

13. A handheld electronic device according to claim 11, further comprising:
g. a speech tips module in communication with the speech recognizer and the user interface output module, the speech tips module using the output module to indicate to the user commands currently available to the user.

14. A handheld electronic device according to claim 13, wherein the speech tips module indicates to the user all commands currently available to the user.

15. A handheld electronic device according to claim 13, wherein the speech tips module operates responsive to a user input signal.

16. A handheld electronic device according to claim 15, wherein the user input signal is operation of a microphone on/off button on the device.

17. A handheld electronic device according to claim 13, wherein the commands currently available to the user are indicated to the user for a predetermined length of time.

18. A handheld electronic device according to claim 17, wherein the predetermined length of time is selectable by the user.

19. A handheld electronic device according to claim 13, wherein when the device is in a selected state, the speech tips module automatically indicates commands currently available.

20. A handheld electronic device according to claim 19, wherein the selected state is a microphone enabled condition.

21. A handheld electronic device according to claim 13, wherein the speech tips module uses a first perceptually distinctive characteristic to indicate global commands that are always available, and a second perceptually distinctive characteristic to indicate context-dependent commands that are currently available.

22. A handheld electronic device according to claim 21, wherein the speech tips module uses a visual display to indicate commands currently available, and wherein the first perceptually distinctive characteristic is a first distinctive text appearance and the second perceptually distinctive characteristic is a second text appearance.

23. A handheld electronic device according to claim 21, wherein the speech tips module uses an audio indication to indicate commands currently available, and wherein the first perceptually distinctive characteristic is a first voice, and the second perceptually distinctive characteristic is a second voice.

24. A handheld electronic device according to claim 1, further comprising:
h. an audio processor including:
i. a microphone module that generates an electrical signal representative of a spoken input from the user, and provides the electrical signal to the speech pre-processor, and
ii. an output module that generates sound intended for the user; and
i. an audio duplexing module responsive to a current state of the device, the duplexing module enabling one module in the processor to operate and disabling the other module from operation.

25. A handheld electronic device according to claim 24, wherein the audio duplexing module is further responsive to a user input signal.

26. A handheld electronic device according to claim 25, wherein the user input signal is operation of a microphone on/off button on the device.

27. A handheld electronic device according to claim 24, wherein the device further indicates to a user which module is currently enabled by the audio duplexing module.

28. A handheld electronic device according to claim 24, wherein the audio duplexer is further responsive to a user command.

29. A handheld electronic device according to claim 1, wherein the recognition output represents a command to control operation of the device.

30. A handheld electronic device according to claim 1, wherein the device is a personal digital assistant (PDA) device having a personal information manager (PIM) application.

31. A handheld electronic device comprising:
a. a plurality of application processes available for interaction with a user, including:
i. a speech recognition process that processes input speech from a user, and produces a recognition output representative of the input speech,
ii. a text-to-speech process that processes output text, and produces a representative speech output, and
iii. an audio recorder process that processes input audio, and produces a representative audio recording output;
b. an audio processor including
i. a microphone module that generates an electrical signal representative of a spoken input from the user, and
ii. an output module that generates sound intended for the user; and
c. an audio duplexing module responsive to a current state of the device, the duplexing module enabling one module in the processor to operate and disabling the other module from operation.

32. A handheld electronic device according to claim 31, wherein the duplexing module is further responsive to operation of a microphone on/off button on the device.

33. A handheld electronic device according to claim 31, further comprising:
d. a user interface display that displays visual information to the user, and wherein the duplexing module is further responsive to selection of a microphone icon on the display.

34. A handheld electronic device according to claim 33, wherein the user interface display displays text to the user, the text being representative of the recognition output.

35. A handheld electronic device according to claim 31, wherein the audio output module generates an audio cue output for the user each time the speech recognizer generates a recognition output.

36. A handheld electronic device according to claim 31, further comprising:
e. a speech manager interface that allows the speech recognition process and the text-to-speech process to be accessed by other processes, so as to prevent more than one instantiation of the speech recognition process and one instantiation of the text-to-speech process at any given time.

37. A handheld electronic device according to claim 36, wherein the speech manager interface further includes a dialog manager that manages a plurality of speech recognition grammars, each grammar being associated with at least one process, the dialog manager selecting a current recognition grammar for the speech recognition process, the current recognition grammar being associated with a currently selected process.

38. A handheld electronic device according to claim 31, further comprising:
f. a speech tips module in communication with the speech recognition that indicates to the user commands currently available to the user.

39. A handheld electronic device according to claim 38, wherein the speech tips module indicates to the user all commands currently available to the user.

40. A handheld electronic device according to claim 38, wherein the speech tips module operates responsive to a user input signal.

41. A handheld electronic device according to claim 40, wherein the user input signal is operation of a microphone on/off button on the device.

42. A handheld electronic device according to claim 38, wherein the commands currently available to the user are indicated to the user for a predetermined length of time.

43. A handheld electronic device according to claim 42, wherein the predetermined length of time is selectable by the user.

44. A handheld electronic device according to claim 38, wherein when the device is in a selected state, the speech tips module automatically indicates commands currently available.

45. A handheld electronic device according to claim 44, wherein the selected state is a microphone enabled condition.

46. A handheld electronic device according to claim 38, wherein the speech tips module uses a first distinctive voice to indicate global commands that are always available, and a second distinctive voice to indicate context-dependent commands that are currently available.

47. A handheld electronic device according to claim 38, wherein the device further includes a user interface display that displays visual information to the user, and wherein the first perceptually distinctive characteristic is a first distinctive text appearance and the second perceptually distinctive characteristic is a second text appearance.

48. A handheld electronic device according to claim 31, wherein the speech recognition process uses a database of acoustic models, each acoustic model representing a word or subword unit in a recognition vocabulary, each acoustic model being representative of its associated word or subword unit as spoken in a plurality of acoustic environments.

49. A handheld electronic device according to claim 35, wherein the database further includes acoustic models for non-word sounds, and no recognition output is generated when the speech recognition process determines that a non-word sound acoustic model represents the input speech.

50. A handheld electronic device according to claim 31, wherein the recognition output represents a command to control operation of the device.

51. A handheld electronic device according to claim 31, wherein the recognition output represents a command to one of the plurality of application processes

52. A handheld electronic device according to claim 31, wherein the device is a personal digital assistant (PDA) device having a personal information manager (PIM) application process.

53. A handheld electronic device having a plurality of application processes, the device comprising:
a. a speech recognition process that processes input speech from a user, and produces a recognition output representative of the input speech;
b. a text-to-speech process that processes output text, and produces a representative speech output;
c. a speech manager interface that allows the speech recognition process and the text-to-speech process to be accessed by other processes, so as to prevent more than one instantiation of the speech recognition process and one instantiation of the text-to-speech process at any given time.

54. A handheld electronic device according to claim 53, wherein the speech manger interface further includes a dialog manager that manages a plurality of speech recognition grammars, each grammar being associated with at least one process, the dialog manager selecting a current recognition grammar for the speech recognition process, the current recognition grammar being associated with a current process.

55. A handheld electronic device according to claim 54, wherein the speech recognition application process is speaker independent.

56. A handheld electronic device according to claim 54, wherein the recognition output represents a command to one of the plurality of application processes.

57. A handheld electronic device according to claim 54, wherein the recognition output represents a command to control operation of the device.

58. A handheld electronic device according to claim 53, wherein the device is a personal digital assistant (PDA) device having a personal information manager (PIM) application process.
